(19) United States
(12) Patent Application Publication
(10) Pub. No.: US 2004/0138908 A1
(43) Pub. Date: Jul. 15, 2004

(54) Method for analyzing warranty claim data

(76) Inventors: Victor Lowe JR., Ann Arbor, MI (US); Steve Wachs, West Bloomfield, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/669,907

(22) Filed: Sep. 24, 2003

Related U.S. Application Data
(63) Continuation-in-part of application No. 09/537,123, filed on Mar. 29, 2000, now abandoned.

(51) Int. Cl. G06F 17/60

(52) U.S. Cl. 705/1

(57) ABSTRACT

A method for evaluating warranty claims by the use of a proportionality metric and control chart is employed. The method allows for the detection of emerging concerns from the warranty claims data.

### CROSS REFERENCE TO RELATED APPLICATIONS

This is a continuation in part and claims the benefit of U.S. patent application Ser. No. 09/537,123, filed Mar. 29, 2000, all of which is incorporated herein by reference.

### BACKGROUND OF INVENTION

The present invention generally relates to a method for analyzing warranty claim data and more particularly to a method for analyzing warranty claim data that can detect potential emerging concerns from warranty claim data.

High warranty costs substantially reduce or may even eliminate any profit for goods produced by manufacturers, as well as reduce customer satisfaction with the goods. Thus, considerable effort is made by manufacturers to minimize warranty costs by creating robust product designs, stable manufacturing processes, and quality operating processes. In addition, when a potential quality concern arises anyway, it is critical to minimize its impact by detecting and correcting the cause of the concern as soon as possible. Consequently, it is desirable for a manufacturer of goods to have a means for timely and accurate assessment of the amount and trends of warranty claims associated with or related to the produced goods. This information would allow the manufacturer to be aware of potentially undesirable characteristics associated with these goods. Such information could allow the manufacturer to begin to quickly and efficiently determine the cause of and eliminate the undesirable characteristics, thus improving the overall quality of the goods. Such information could also allow the manufacturer to continuously monitor the quality of the goods in order to ensure that the overall quality of the goods is maintained at a relatively high and acceptable quality standard.

Traditionally, warranty claim information is collected over a certain predetermined and relatively long period of time for a particular item and is subjected to a conventional statistical control process or methodology which utilizes the collected information to create control bands on a P-chart. Particularly, these control bands typically represent an acceptable range of received warranty claims for that particular item and are used to analyze warranty claims which are collected during other intervals of time for that item. Particularly, the warranty claims which are collected during these other intervals of time are counted and the number of received claims is compared to the previously created bands since it is known that a change in the overall quality of this item causes the number of received warranty claims to fall outside of the previously created control band. That is, when the number of collected claims are below these bands, an improvement in the overall quality of the item has typically occurred, while the quality of the item has usually degraded when the number of received warranty claims is above these bands.

While this prior process control methodology does provide some indication of the amount of warranty claim information and some indication of overall product quality, it frequently requires a relatively large amount of historical data and a relatively large sample of acquired data, and therefore fails to provide a timely indication of a warranty concern. Moreover, this prior methodology tends to provide false or inaccurate quality indicators, especially when used to analyze or track a relatively small amount of warranty claim information associated with a particular item.

In addition, conventional methods of statistical process control that are typically employed in a manufacturing environment—where processes are monitored to ensure that critical process inputs are stable in order to result in a predicable output—are not directly applicable to a warranty repair process. The manufacturing environment lends itself to inherently stable processes where a statistic being plotted follows a generally normal distribution, and the sample size (total items sampled) can be preselected to achieve accurate results. This is not the case when measuring warranty claims for a product, which is an inherently unstable process, in that, the failure rates usually vary over time.

There is therefore a need for a method for analyzing warranty claim data which overcomes some or all of the previously delineated drawbacks of prior methods.

### SUMMARY OF INVENTION

According to an embodiment of the present invention, a method for analyzing warranty claims data is provided. The method comprises the steps of: receiving first warranty claim data for a first item over a first time interval; receiving first warranty claim data for at least one second item over the first time interval; generating a statistical control chart for the first item, including at center line and an upper control limit, by employing a statistical process control methodology; receiving second warranty claim data for the first item over a second time interval that is subsequent to the first time interval; receiving second warranty claim data for the at least one second item over the second time interval; creating a proportionality metric for the first item relative to the second time interval; comparing the proportionality metric to the upper control limit; and generating a report when the proportionality metric exceeds the upper control limit.

An embodiment of the present invention further contemplates a method for analyzing warranty data comprising the steps of: receiving first warranty claim data for a first item over a first time interval, with the first time interval including a plurality of subintervals and the number of warranty claims for the first item in each subinterval within the plurality of subintervals; receiving the number of the first item covered under warranty for each subinterval in the plurality of subintervals; creating a P-value for each subinterval in the plurality of subintervals by dividing the number of warranty claims for the first item in each of the subintervals by the number of first items in service for the corresponding subinterval; generating a statistical control chart for the first item, including at center line and an upper control limit, by employing a statistical process control methodology to the P-values created for each of the subintervals; receiving second warranty claim data for the first item over a second time interval that is subsequent to the first time interval, including the number of warranty claims and the number of first items in service in the second time interval; creating a proportionality metric for the first item relative to the second time interval by dividing the number of warranty claims in the second time interval by the number of the first item in service in the second time interval; comparing the proportionality metric to the upper control limit; and generating a report when the proportionality metric exceeds the upper control limit.

An embodiment of the present invention also contemplates, in an information processing and storing apparatus, a method for analyzing warranty data comprising the steps of: receiving first warranty claim data for a first item over a first time interval, with the first time interval including a first plurality of subintervals and the number of warranty claims for the first item in each subinterval within the first plurality of subintervals; receiving the number of the first item covered under warranty for each subinterval in the first plurality of subintervals; creating a P-value for each subinterval in the first plurality of subintervals by dividing the number of warranty claims for the first item in each of the subintervals by the number of first items in service for the corresponding subinterval; receiving second warranty claim data for the first item over a second time interval that is subsequent to the first time interval, with the second time interval including a second plurality of subintervals, each equal in length to corresponding subintervals of the first time interval, including the number of warranty claims and the number of first items in service in each subinterval within the second plurality of subintervals; creating a P-value for each subinterval in the second plurality of subintervals by dividing the number of warranty claims for the first item in each of the subintervals by the number of first items in service for the corresponding subinterval; subtracting the P-values in each interval in the second plurality of subintervals from the P-values in each corresponding subinterval in the first plurality of subintervals to create a plurality of difference P-values; generating a statistical control chart for the first item, including at center line and an upper control limit, by employing a statistical process control methodology to the plurality of difference P-values; comparing the difference P-value for at least one subinterval of the second plurality of subintervals to the upper control limit; and generating a report when the difference P-value for the at least one subinterval of the second plurality of subintervals exceeds the upper control limit.

An advantage of the present invention is that it quickly detects emerging quality concerns from warranty claims data associated with particular manufactured goods and items—even though, as it relates to statistical analysis, warranty claims data results from an inherently unstable process.

Another advantage of the present invention is that, when quality trends associated with the particular manufactured goods and items shown a quality concern, the quality concern can be addressed in a very timely manner.

A further advantage of an embodiment of the present invention is a high sensitivity for detection of emerging concerns by employing additional statistical process control measurements in addition to applying upper and lower control limits to the warranty claims data.

These and other features, aspects, and advantages of the present invention will become apparent from reading the following detailed description of the invention and by reference to the following drawings.

### BRIEF DESCRIPTION OF DRAWINGS

FIG. 1 is a schematic diagram illustrating a system for carrying out the warranty claim data process in accordance with an embodiment of the present invention.

FIG. 2 is a schematic diagram illustrating the processing architecture that is preferably employed in carrying out the warranty claim data process in accordance with an embodiment of the present invention.

FIG. 3 is a flowchart illustrating steps included within the methodology of a preferred embodiment of the present invention.

### DETAILED DESCRIPTION

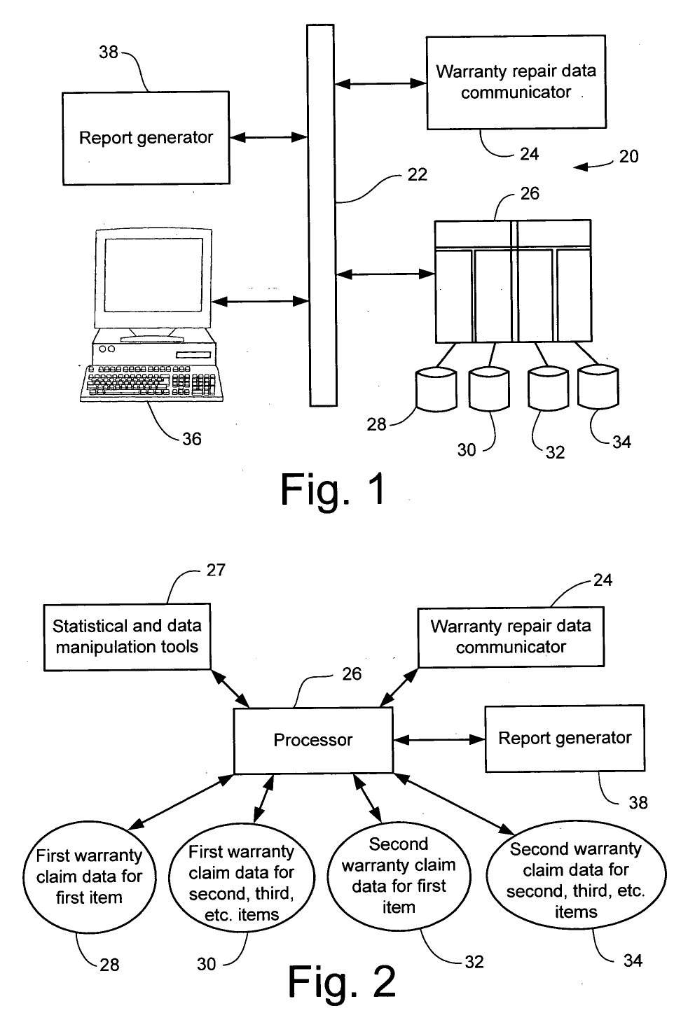

FIGS. 1 and 2 illustrate a schematic of a system 20 for carrying out a warranty claim process. This system preferably includes a conventional network or interconnected networks 22—which can be for example the internet, a local area network, a virtual private network, etc.—through which various components of the system 20 communicate. A mechanism 24 for communicating warranty repair data connects to the network 22. This mechanism 24 may include communication by electronic reporting, such as via the internet or telephone, or initial paper reporting, such as via mail or facsimile, which is entered into the system through conventional data processing techniques, or a combination of these communication mechanisms. A processor 26, with statistical and other data manipulation tools 27— preferably embodied by software—for receiving and manipulating data, and memory 28, 30, 32, 34, for storing the data, is also preferably connected to the network 22. The system 20 preferably includes a general purpose computer 36, such as a personal computer, and a mechanism for generating reports 38. The report generator 38 is preferably in the form of a paper printout, an automatic e-mail or other conventional means of communication. Of course, this system may, as an alternative, include the processor 26, memory 28, 30, 32, 34, and/or general purpose computer 36 as a single unit, if so desired.

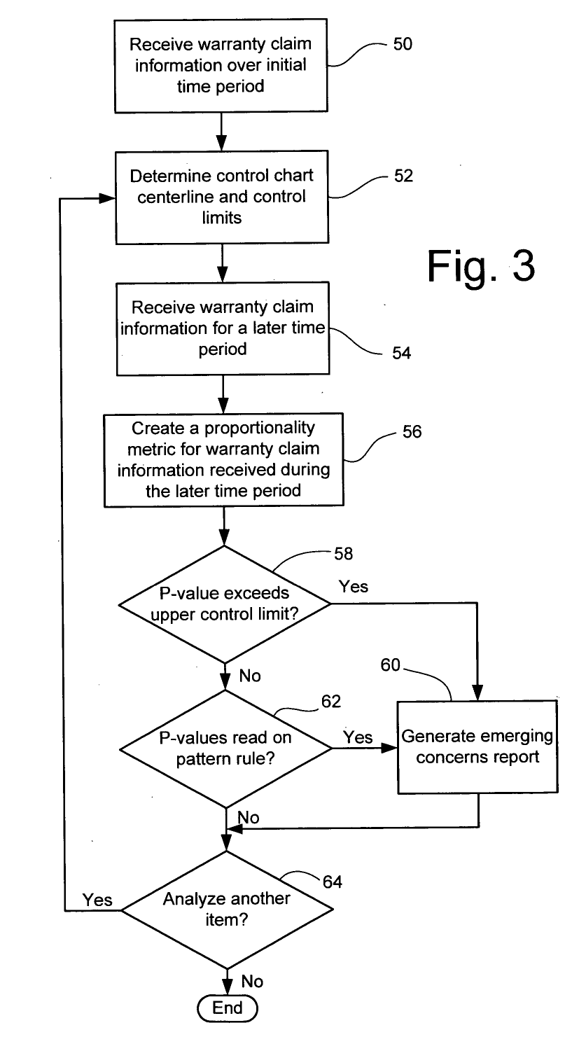

Referring to FIG. 3, there is shown a flowchart 10 which illustrates the methodology of a preferred embodiment of the invention as may be carried out with the system 20 illustrated in FIGS. 1 and 2. The methodology discussed below will be discussed relative to a vehicle manufacturer as an example, although other types of goods sold under warranty where warranty reports are received may also employ this methodology. When discussing this example for applying the methodology as it relates to vehicles, the vehicles for a particular model and year will overall be considered the goods, while an item may be a particular subassembly, part, or attribute of a subassembly or part that makes up this vehicle. That is, an item may be an individual part, such as a camshaft, a subassembly, such as a motor for a power window, or an attribute, such as the condition of the paint on the exterior of the vehicle, since any one of these items may cause a warranty claim. Goods other than vehicles can, of course, be defined and broken down in different ways depending upon the type of goods and how fine of a breakdown is desired for measuring the warranty claims data when desiring to detect emerging warranty concerns. For particular types of products, for example, a line of different products may be defined as the goods, with any one product in this line defined as an item. It also may be broken down by the manufacturing plant at which it is produced, or groupings of similar products may be defined as particular goods. In any event, consistency in carrying meaningful definitions of goods and items through the methodology, and preferably large sample sizes, support obtaining good results from the methodology employed herein.

The process includes receiving warranty claim information for particular goods for an initial time period, step 50. Due to the very large volumes of data that is typically received for commercial products, receiving, sorting and storing this information is preferably all accomplished on a system as illustrated in FIGS. 1 and 2. In the example being discussed herein, the particular goods would be a model and year of vehicle, while the time period is preferably an entire model year of that model and year of vehicle. The warranty claim information received would be broken down by the items for which one would like to detect potential emerging warranty concerns. If so desired, for the first year of a model of a vehicle, one may wish to substitute historical data from a similar vehicle temporarily until adequate data is collected for creating control charts, discussed below.

For the particular item to be analyzed, a control chart, also known as a P-chart, is developed employing statistical processes to determine a centerline, with upper and lower control limits set on either side of the centerline, step 52. The control chart employed herein is modified from a conventional control chart and has a centerline that is preferably an adjusted mean calculated from the initial time period, with the control limits set at plus and minus 3-sigma from the adjusted mean. The adjusted mean is calculated by taking the warranty claim data for that item over the initial time period (e.g. one model year) and replacing all P-values that exceed plus or minus 3-sigma with the actual 3-sigma value. The P-values are determined by dividing the number of warranty claims for an item during a given subinterval within the initial time period by the total number of warranty claims for the goods during that subinterval. For example, the subinterval may be a week within the model year, so the P-value for that item for that particular week is the number of warranty claims for the item for the week divided by the total number of warranty claims for that same week associated with that vehicle model and year. This P-value calculation, then, will normalize the claims for that item in any given week, even though the number of goods (vehicles for that model and year) increases from one week to the next. Moreover, this normalizing is significant since the conventional way for calculating a P-value, in a manufacturing setting for example, is to divide the number of defects for that item by the total number of items sampled. In the case of reported warranties, there is no testing or any such sample of total items tested, just reports of items that required warranty work.

Now that a control chart for the item under consideration is determined, it can be used for analyzing future reports of warranty claims. It is particularly useful for comparing to warranty claims for the particular item on the following year's vehicle of the same model. Warranty claim information for a later time period is received for the item in question as well as all warranty claims for the model and year vehicle that the item is being used on, step 54. The later time period may be, for example, all claims received for a give week for that year's or the following year's model vehicle.

A proportionality metric (P-value) is created for that item for the later time period, step 56. The P-value for that item is determined by dividing the number of claims for the item for the later time period by the total number of claims for the later time period (for that vehicle model and year). All of the warranty claims used in the creation of this proportionality metric should ideally reside within or be reported within the same time period for which the analysis is to be conducted. In this manner a relatively accurate warranty analysis may be achieved within a relatively short and discrete interval of time (e.g., daily, weekly), thereby allowing warranty concerns to be identified in a timely manner.

This proportionally metric (P-value) is then compared to the control chart to determine if it exceeds the upper control limit, step 58. If it does, then an emerging concerns report is generated, step 60. The lower control limit is not considered (which is not the case with conventional manufacturing statistical process controls) since a value below the lower control limit would indicate an improvement in quality, which is not a concern.

The P-value is then considered, along with previous consecutive P-values for that item, in order to determine if it reads on a pattern rule, step 62. If there are enough P-values within a particular model and year of vehicle, then they can be considered. Otherwise, this step may be skipped very early in a model year, or some P-values from the end of the previous year may be used, if applicable and so desired. The pattern rules are a way to detect a potential concern when consecutive P-values exhibit some non-random pattern of behavior even through not falling outside of the control limits. Since this methodology employs a process that is different than a standard statistical process control as employed in a manufacturing environment, only certain pattern rules will be applicable. Moreover, the pattern rules, or portions thereof, as far as the pattern may indicate a quality improvement will not be employed since the intent herein is to detect emerging quality concerns from warranty repairs. Even though employing the pattern rules may slightly increase the number of false concerns reported (i.e. conclude an item has an emerging quality concern when in fact it does not), the increase in sensitivity of the control charts in quickly identifying potential emerging quality concerns is believed to outweigh this. However, one may skip step 62 if believed to be unneeded for the particular items and goods being evaluated.

Four pattern rules are preferably applied in step 62. The first pattern rule is having nine P-values in a row that are above the centerline, which indicates a need to generate an emerging concerns report. While conventional statistical process control would also look at a series of P-values all below the centerline, this is not a concern herein since our modified control chart would indicate that values below the centerline represent a potential quality improvement. The second pattern rule is having six P-values in a row that are all increasing, which indicates a need to generate an emerging concerns report. (Six decreasing would not be applicable for the reasons discussed above.) The third pattern rule is having two out of three consecutive P-values that are 2-sigma or more above the centerline, which indicates a need to generate an emerging concerns report. (Again, the P-values below the centerline are not of concern). The fourth patter rule is having four out of five consecutive P-values that are 1-sigma or more above the centerline, which indicates a need to generate an emerging concerns report. (P-values below the centerline are not of concern). If the P-values do not read on these pattern rules, or after an emerging concerns report is generated, then one may analyze another item, step 64, or end the statistical review.

It should be realized that the use of this proportionality metric allows the statistical process control to provide a relatively accurate warranty claim analysis in a timely manner and by use of a relatively limited amount of data, effective to allow a product manufacturer to be quickly notified of the existence of undesirable attributes/characteristics of a product. Particularly, by forming control bands with this “percentage data” (i.e., warranty claim data associated with an item to be analyzed divided by the total number of received warranty claims), a relatively small amount of actual warranty claim data may be used while allowing a relatively accurate analysis to be accomplished.

A second embodiment of the invention employs the system of FIGS. 1 and 2, and generally the process indicated in FIG. 3, with process steps 52 and 56 changed somewhat. However, the end result is still a determination of whether emerging concerns for a particular item are present. Also, if so desired, process steps 50 and 54 can be modified by only collecting warranty data for the item of interest rather than other items as well. If this is the case, then step 64 would be eliminated.

In this embodiment, an exposure is used when determining the control chart and calculating the P-values. Exposure is the total number of vehicles for that model and year that are in service and covered by warranty, which, in effect, accounts for the amount of time (e.g. weeks) that vehicles (goods) for that model and year have been in service. Exposure, then, accounts for the fact that vehicles in service have been in service for different amounts of time due to the different production and delivery dates. The weekly exposure, then, for any given week is the total number of vehicles that are in service and covered under warranty during that week. The total exposure for a particular model vehicle and year reflects the population base of interest, with the weekly exposure increasing at a relatively constant rate during the first year, and then remaining relatively constant until vehicles begin to drop out due to expiration of warranty coverage.

Also, since the exposure is, in effect, a sample size, but not in conventional statistical process control terms, it is preferable to employ a standardized control chart (P-chart). Standardizing will make it easier to compare P-values, discussed below, since the P-values need to be interpreted relative to the sample size. When determining the standardized control chart, the plotted points would be (Pi−Pm)/Sigma-Pi, where Pi is the calculated P-value for the particular subinterval (e.g. a week), Pm is the mean P-value, and Sigma-Pi is the standard deviation of Pi. The control limits for this standardized control chart would be +3 and −3, in units of standard deviation. With all of the plotted points standardized in units of standard deviation, relative positions of future P-values can be used to identify potential emerging warranty concerns, as discussed above relative to process steps 58 and 62.

In this second embodiment, step 56 is also modified in that a P-value is calculated by dividing the number of reported warranty claims in the later time period by the exposure. This modified P-value is then compared to the standardized control chart with the same upper control limit and pattern rule comparisons from the first embodiment used to determine if an emerging concerns report needs to be generated.

A third embodiment of the invention is a process that is very similar to the second embodiment, but with the control chart being determined by plotting a standardized differences in proportions chart for step 52 of FIG. 2. This embodiment accounts for the general instability in warranty repair rates over time by plotting the difference between the proportion of repairs (P-value) for the later time period (e.g. a week in the latter model year) with proportion of repairs (P-value) for the corresponding subinterval (e.g. the same week for the previous production year) in the initial time period. The proportion of repairs (P-value) is the number of warranty claims divided by the exposure. This method will create a standardized control chart with the mean close to zero, and with the control limits at +3 and −3. For process step 56, the P-values are calculated by determining (d/sigma-d). In this equation, d=(P1−P2), with P1 being the warranty repairs for the item in the later time period and P2 being the warranty repairs for the item in the corresponding subinterval of the initial time period. Also, sigma-d is a standard error of difference in proportions, which is the square root of the sum of the following two equations: (P1*(1−P1)/N1) and (P2*(1−P2)/N2). The proportionality metrics (P-values) thus created can then be used, in conjunction with the standardized differences in proportions control chart, to determine if the proportionality metrics exceed the upper control limit or read on the appropriate pattern rules, with emerging concerns reports generated, as discussed above.

In other non-limiting embodiments of the invention, conventional data may be used if the ratio or the proportionality metric is equal to one or zero.

While certain embodiments of the present invention have been described in detail, those familiar with the art to which this invention relates will recognize various alternative designs and embodiments for practicing the invention as defined by the following claims.

What is claimed is:

1. A method for analyzing warranty data comprising the steps of:
receiving first warranty claim data for a first item over a first time interval;
receiving first warranty claim data for at least one second item over the first time interval;
generating a statistical control chart for the first item, including at center line and an upper control limit, by employing a statistical process control methodology;
receiving second warranty claim data for the first item over a second time interval that is subsequent to the first time interval;
receiving second warranty claim data for the at least one second item over the second time interval;
creating a proportionality metric for the first item relative to the second time interval;
comparing the proportionality metric to the upper control limit; and
generating a report when the proportionality metric exceeds the upper control limit.

2. The method of claim 1 wherein said second warranty claim data for the first item includes a certain number of claims, the second warranty claim data for the at least one second item includes a certain number of claims; and wherein said proportionality metric is created by adding the certain number of claims for the first item to the certain number of claims for the at least one second item to create a sum, and dividing the certain number of claims for the first item by the sum.

3. The method of claim 1 wherein the step of generating a statistical control chart includes:
determining a plurality of proportionality metrics over consecutive subintervals within the first time interval;
calculating an initial centerline and initial upper and lower control limits;
replacing each proportionality metric, within the plurality of proportionality metrics, that exceeds the initial upper control limits with the upper control limit, and replacing each proportionality metric, within the plurality of proportionality metrics, that is less than the initial lower control limit with the lower control limit to create a modified plurality of proportionality metrics; and
recalculating the centerline based on the modified plurality of proportionality metrics.

4. The method of claim 1 further including the steps of:
receiving third warranty claim data for the first item and for the at least one second item over a third time interval that is consecutive to the second time interval;
creating a second proportionality metric for the first item relative to the third time interval;
receiving fourth warranty claim data for the first item and for the at least one second item over a fourth time interval that is consecutive to the third time interval;
creating a third proportionality metric for the first item relative to the fourth time interval;
receiving fifth warranty claim data for the first item and for the at least one second item over a fifth time interval that is consecutive to the fourth time interval;
creating a fourth proportionality metric for the first item relative to the fifth time interval;
receiving sixth warranty claim data for the first item and for the at least one second item over a sixth time interval that is consecutive to the fifth time interval;
creating a fifth proportionality metric for the first item relative to the sixth time interval;
receiving seventh warranty claim data for the first item and for the at least one second item over a seventh time interval that is consecutive to the sixth time interval;
creating a sixth proportionality metric for the first item relative to the seventh time interval;
receiving eighth warranty claim data for the first item and for the at least one second item over a eighth time interval that is consecutive to the seventh time interval;
creating a seventh proportionality metric for the first item relative to the eighth time interval;
receiving ninth warranty claim data for the first item and for the at least one second item over a ninth time interval that is consecutive to the eighth time interval;
creating a eighth proportionality metric for the first item relative to the ninth time interval;
receiving tenth warranty claim data for the first item and for the at least one second item over a tenth time interval that is consecutive to the ninth time interval;
creating a ninth proportionality metric for the first item relative to the tenth time interval; and
generating a report it the proportionality metric, the second proportionality metric, the third proportionality metric, the fourth proportionality metric, the fifth proportionality metric, the sixth proportionality metric, the seventh proportionality metric, the eighth proportionality metric, and the ninth proportionality metric are all above the centerline.

5. The method of claim 1 further including the steps of:
receiving third warranty claim data for the first item and for the at least one second item over a third time interval that is consecutive to the second time interval;
creating a second proportionality metric for the first item relative to the third time interval;
receiving fourth warranty claim data for the first item and for the at least one second item over a fourth time interval that is consecutive to the third time interval;
creating a third proportionality metric for the first item relative to the fourth time interval;
receiving fifth warranty claim data for the first item and for the at least one second item over a fifth time interval that is consecutive to the fourth time interval;
creating a fourth proportionality metric for the first item relative to the fifth time interval;
receiving sixth warranty claim data for the first item and for the at least one second item over a sixth time interval that is consecutive to the fifth time interval;
creating a fifth proportionality metric for the first item relative to the sixth time interval;
receiving seventh warranty claim data for the first item and for the at least one second item over a seventh time interval that is consecutive to the sixth time interval;
creating a sixth proportionality metric for the first item relative to the seventh time interval; and
generating a report if the proportionality metric, the second proportionality metric, the third proportionality metric, the fourth proportionality metric, the fifth proportionality metric, and the sixth proportionality metric are increasing in value from the proportionality metric through the sixth proportionality metric.

6. The method of claim 1 further including the steps of calculating a 2-sigma limit above the centerline for the statistical control chart;
receiving third warranty claim data for the first item and for the at least one second item over a third time interval that is consecutive to the second time interval;
creating a second proportionality metric for the first item relative to the third time interval;
receiving fourth warranty claim data for the first item and for the at least one second item over a fourth time interval that is consecutive to the third time interval;
creating a third proportionality metric for the first item relative to the fourth time interval; and
generating a report if at least two of the proportionality metric, the second proportionality metric and the third proportionality metric are greater than the 2-sigma limit.

7. The method of claim 1 further including the steps of:
calculating a 1-sigma limit above the centerline for the statistical control chart;
receiving third warranty claim data for the first item and for the at least one second item over a third time interval that is consecutive to the second time interval;
creating a second proportionality metric for the first item relative to the third time interval;
receiving fourth warranty claim data for the first item and for the at least one second item over a fourth time interval that is consecutive to the third time interval;
creating a third proportionality metric for the first item relative to the fourth time interval;
receiving fifth warranty claim data for the first item and for the at least one second item over a fifth time interval that is consecutive to the fourth time interval;
creating a fourth proportionality metric for the first item relative to the fifth time interval;
receiving sixth warranty claim data for the first item and for the at least one second item over a sixth time interval that is consecutive to the fifth time interval;
creating a fifth proportionality metric for the first item relative to the sixth time interval; and
generating a report if at least four of the proportionality metric, the second proportionality metric, the third proportionality metric, the fourth proportionality metric, and the fifth proportionality metric are greater than the 1-sigma limit.

8. The method of claim 1 wherein the first item and the at least one second item each comprise one of a part, subassembly or an attribute of a vehicle.

9. The method of claim 1 wherein the step of receiving first warranty claim data for a first item over a first time interval includes receiving the number of first items that are in service for a plurality of subintervals within the first time interval, and receiving the number of warranty claims for the first item within each subinterval of the plurality of subintervals; and the step of generating a statistical control chart includes, for each subinterval in the plurality of subintervals, dividing the number of warranty claims for the subinterval by the number of first items in service for the corresponding subinterval to create a plurality of P-values, and determining the centerline and the upper control limit from the plurality of P-values.

10. The method of claim 9 wherein the step of generating a statistical control chart includes standardizing the control chart in units of standard deviation.

11. The method of claim 10 wherein standardizing the control chart includes standardizing each of the P-values in the plurality of P-values by calculating a mean P-value from the plurality of P-values, calculating a standard deviation for each of the P-values in the plurality of P-values, and determining a standardized P-value for each of the P-values in the plurality of P-values by subtracting the mean P-value from each of the P-values in the plurality of P-values to create a plurality of difference P-values, and then dividing each P-value in the plurality of difference P-values by the corresponding standard deviation for each of the P-values in the plurality of P-values.

12. A method for analyzing warranty data comprising the steps of:
receiving first warranty claim data for a first item over a first time interval, with the first time interval including a plurality of subintervals and the number of warranty claims for the first item in each subinterval within the plurality of subintervals;
receiving the number of the first item covered under warranty for each subinterval in the plurality of subintervals;
creating a P-value for each subinterval in the plurality of subintervals by dividing the number of warranty claims for the first item in each of the subintervals by the number of first items in service for the corresponding subinterval;
generating a statistical control chart for the first item, including at center line and an upper control limit, by employing a statistical process control methodology to the P-values created for each of the subintervals;
receiving second warranty claim data for the first item over a second time interval that is subsequent to the first time interval, including the number of warranty claims and the number of first items in service in the second time interval;
creating a proportionality metric for the first item relative to the second time interval by dividing the number of warranty claims in the second time interval by the number of the first item in service in the second time interval;
comparing the proportionality metric to the upper control limit; and
generating a report when the proportionality metric exceeds the upper control limit.

13. The method of claim 9 wherein the step of generating a statistical control chart includes standardizing the control chart in units of standard deviation.

14. The method of claim 10 wherein standardizing the control chart includes standardizing the P-value for each subinterval by calculating a mean P-value from the P-value in each subinterval, calculating a standard deviation for each of the P-values in each of the subintervals, and determining a standardized P-value for each subinterval by subtracting the mean P-value from the P-value in each subinterval to create a difference P-value in each interval, and then dividing each of the difference P-values by the corresponding standard deviation.

15. The method of claim 12 further including:
receiving a plurality of warranty claim data for a corresponding plurality of time intervals equal in length and subsequent to the second time interval;
creating a plurality of proportionality metrics, with each of the proportionality metrics in the plurality of proportionality metrics corresponding to one of the time intervals in the plurality of time intervals;
comparing the plurality of proportionality metrics to a pattern rule; and
generating a report if any of the proportionality metrics match the pattern rule.

16. In an information processing and storing apparatus, a method for analyzing warranty data comprising the steps of:
receiving first warranty claim data for a first item over a first time interval, with the first time interval including a first plurality of subintervals and the number of warranty claims for the first item in each subinterval within the first plurality of subintervals;
receiving the number of the first item covered under warranty for each subinterval in the first plurality of subintervals;
creating a P-value for each subinterval in the first plurality of subintervals by dividing the number of warranty claims for the first item in each of the subintervals by the number of first items in service for the corresponding subinterval;
receiving second warranty claim data for the first item over a second time interval that is subsequent to the first time interval, with the second time interval including a second plurality of subintervals, each equal in length to corresponding subintervals of the first time interval, including the number of warranty claims and the number of first items in service in each subinterval within the second plurality of subintervals;
creating a P-value for each subinterval in the second plurality of subintervals by dividing the number of warranty claims for the first item in each of the subintervals by the number of first items in service for the corresponding subinterval;
subtracting the P-values in each interval in the second plurality of subintervals from the P-values in each corresponding subinterval in the first plurality of subintervals to create a plurality of difference P-values;
generating a statistical control chart for the first item, including at center line and an upper control limit, by employing a statistical process control methodology to the plurality of difference P-values;
comparing the difference P-value for at least one subinterval of the second plurality of subintervals to the upper control limit; and
generating a report when the difference P-value for the at least one subinterval of the second plurality of subintervals exceeds the upper control limit.

17. The method of claim 16 further including the steps of calculating a plurality of standard error difference in proportion for each subinterval of the second plurality of subintervals; and normalizing the plurality of P-values relative to the corresponding standard error difference from the plurality of standard error difference in proportion.

18. The method of claim 17 further including:
comparing the plurality of difference P-values to a pattern rule; and
generating a report if at least some of the difference P-values in the plurality of difference P-values match the pattern rule.
